(19) United States
(12) Patent Application Publication
(10) Pub. No.: US 2013/0320648 A1
(43) Pub. Date: Dec. 5, 2013

(54) SCOOTER

(71) Applicants: CAMERON ECKERT, Chicago, IL (US); Ian Grout, Chicago, IL (US); Ross Bartels, Chicago, IL (US); Tyler Cross, Chicago, IL (US)

(72) Inventors: CAMERON ECKERT, Chicago, IL (US); Ian Grout, Chicago, IL (US); Ross Bartels, Chicago, IL (US); Tyler Cross, Chicago, IL (US)

(21) Appl. No.: 13/489,102

(22) Filed: Jun. 5, 2012

(51) Int. Cl. B62M 1/00; B60G 7/02

(52) U.S. Cl. 280/279; 280/281.1; 280/124.128

(57) ABSTRACT

A scooter includes a frame having a leading portion and a trailing portion. A front wheel is attached to the leading portion of the frame. The leading portion of a swing arm is pivotally attached to the trailing portion of the frame. A rear wheel is attached to the trailing portion of the swing arm. A rear fender is also attached to the swing arm. A shock absorber is positioned between the swing arm and the frame so that the shock absorber is compressed when the swing arm pivots in a first direction. A downward swing arm stop limits pivoting of the swing arm in a second direction opposite of the first direction.

### FIELD OF THE INVENTION AND BACKGROUND

The present invention relates to scooters and, more particularly, to a kick scooter having a rear suspension system.

Kick scooters are popular with children as they are fun to ride and provide a means of transport. A kick scooter typically includes a deck, upon which the rider stands, and a rear wheel attached to the rear or trailing portion of the deck. A front wheel is typically pivotally attached to the front or leading portion of the deck via a steering column having a pair of forks at the bottom end that receive the front wheel. The steering column typically pivots with the front wheel, with respect to the deck, and extends upwards from the deck and features a pair of handgrips at the top end so that the scooter may be steered by the rider.

Kick scooters are often ridden on surfaces that feature bumps, cracks and/or other surface irregularities. It is therefore desirable to provide the rear wheel of a kick scooter with a suspension system to help absorb shocks created by such surfaces and provide the rider with a smoother ride. It is further desirable to provide a scooter suspension system that is durable and economical to construct and assemble.

### BRIEF DESCRIPTION OF THE DRAWINGS

FIG. 1 is a top perspective view of an embodiment of the scooter of the present invention;

FIG. 2 is an exploded view of the deck frame, deck and swing arm assembly of the scooter of FIG. 1;

FIG. 3 is a top perspective view of the assembled deck frame, deck and swing arm assembly of the scooter of FIGS. 1 and 2;

FIG. 4 is a partial bottom perspective view of the assembled rear portion of the deck frame and swing arm assembly of FIG. 3, with the swing arm illustrated in phantom;

FIG. 5 is a side elevational view of the rear portion of the assembled deck frame and swing arm assembly of the FIG. 4 with the components positioned within the swing arm illustrated in phantom;

FIGS. 6A and 6B illustrate the swing arm assembly of the scooter of FIGS. 1-5 in the unloaded and loaded conditions, respectively.

### DETAILED DESCRIPTION OF EMBODIMENTS

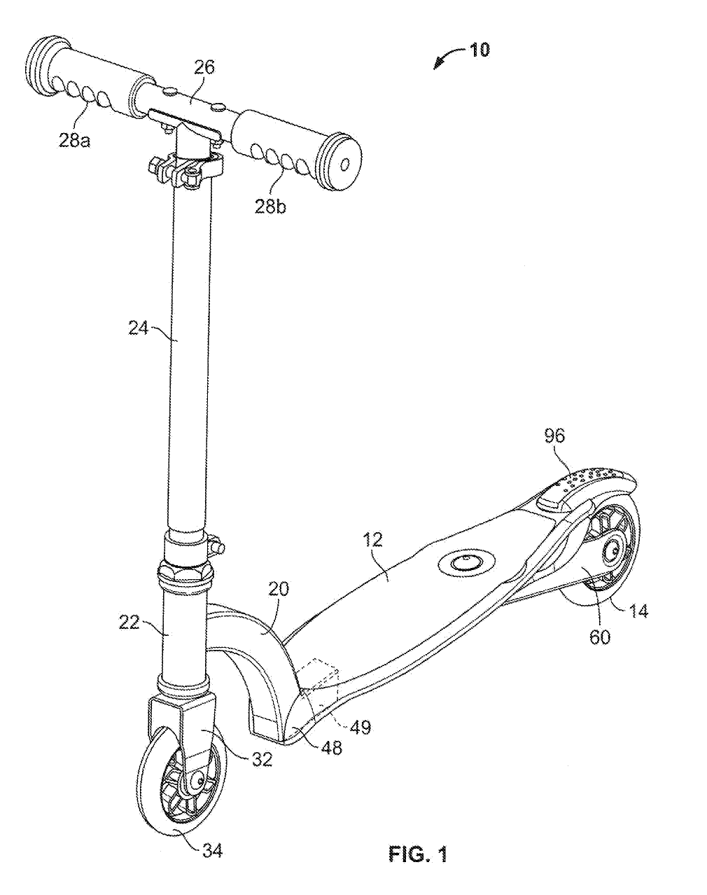

An embodiment of the scooter of the present invention is indicated in general at 10 in FIG. 1. While the invention is described in terms of a scooter, it is to be understood that the suspension system of the present invention may be incorporated in other types of vehicles and toys. As illustrated in FIG. 1, the scooter 10 includes a deck 12 upon which a rider stands. As will be explained in greater detail, a rear wheel 14 is mounted adjacent to the trailing portion of deck by a swing arm 60. A front assembly includes a gooseneck member 20 mounted adjacent to the leading portion of the deck 12 and to which a head tube 22 is secured. A steering column 24 passes through the head tube and is secured therein in a pivoting fashion. A handlebar 26 is mounted at the top end of the steering column and features a pair of handgrips 28a and 28b. A front fork 32 is mounted to the bottom end of the steering column. The front wheel 34 of the scooter is received within the front fork. As a result, a rider standing on the deck 12 of the scooter may turn the front wheel 34 by turning handlebar 26 to the right or left via handgrips 28a and 28b.

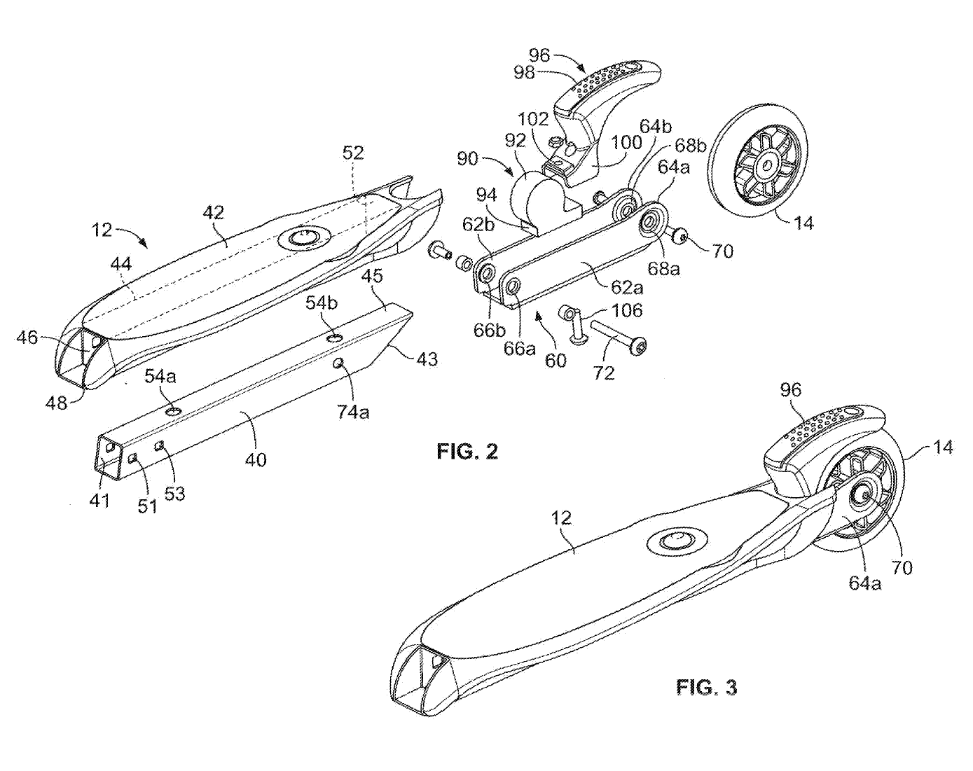

With reference to FIG. 2, the scooter also features a deck frame 40. Deck frame 40 is preferably constructed of steel and takes the form of a tube having a square cross section. The deck frame may be constructed so as to feature a cross sectional shape other than square and may alternatively be made out of a rigid material other than steel. The deck frame 40 features an open front or leading end 41 and an open rear or trailing end 43. The trailing end 43 of the deck frame 40 is cut at an angle to provide overhang portion 45.

Deck 12 is preferably constructed from molded plastic (although wood or other materials may be used) and features a generally flat top surface 42 upon which a rider stands. The underside of the deck is provided with a channel, indicated in phantom at 44 in FIG. 3, that is sized and shaped to receive deck frame 40. The front of the channel 46 is open and is positioned adjacent to socket 48. The rear of the deck channel 44, indicated in phantom at 52 in FIG. 3, is also open. The deck frame 40 provides support for the deck 12 and is secured thereto by appropriate fasteners, such as screws, passing through openings 54a and 54b of the deck frame.

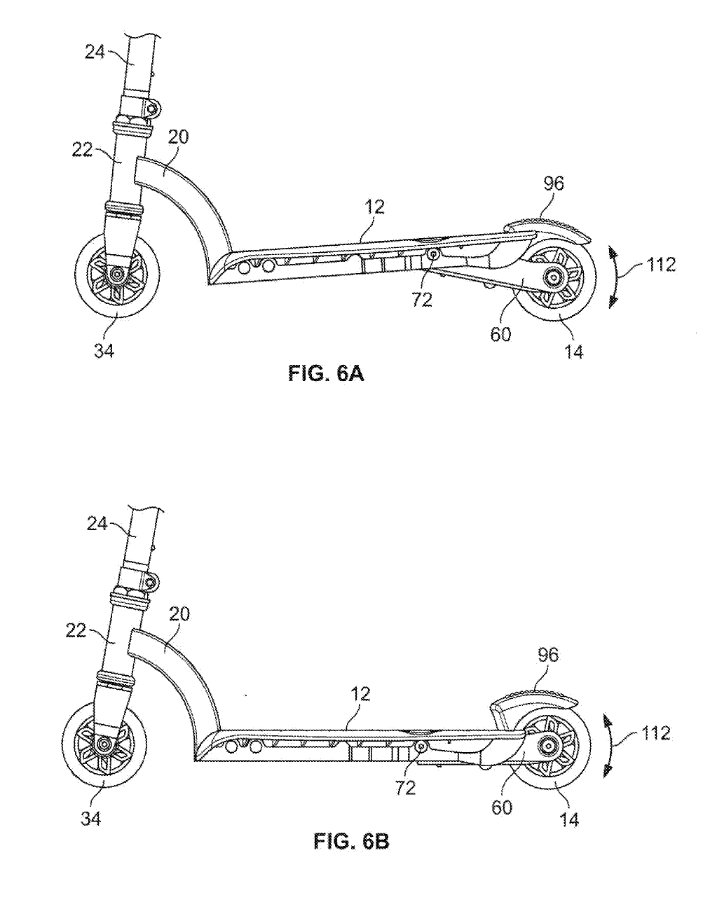

The trailing end of the gooseneck member 20 of the front assembly (FIGS. 1, 6A and 6B) is attached to the open front end 41 of the deck frame 40 and is positioned within the socket 48 of the deck 12. The trailing end of the gooseneck member 20 preferably includes a horizontal extension (indicated in phantom at 49 in FIG. 1) that is inserted through the open front end 41 of the deck frame in a socket fashion. Bolts pass through the overlapping portions of the deck frame (through openings 51 and 53 in FIG. 2) and the horizontal extension 49 (FIG. 1) of the gooseneck member to hold the two components together. Other fastening arrangements known in the art including, but not limited to, welding may be used to secure the gooseneck member 20 to the deck frame 40.

A swing arm, indicated in general at 60 in FIG. 2, is preferably constructed of steel (although any durable, rigid material may be used). The swing arm features a generally U-shaped cross section so as to have opposing sidewalls 62a and 62b. As illustrated in FIGS. 2-4, the trailing end of the swing arm is bifurcated to form ears 64a and 64b. The leading end of the swing arm features openings 66a and 66b formed through sidewalls 62a and 62b, respectively. Ears 64a and 64b at the trailing end of the swing arm feature openings 68a and 68b.

As illustrated in FIGS. 2-4, the rear wheel 14 of the scooter is received between the ears 64a and 64b at the rear of the swing arm and is rotatably secured in place by bolt 70, which passes through openings 68a and 68b.

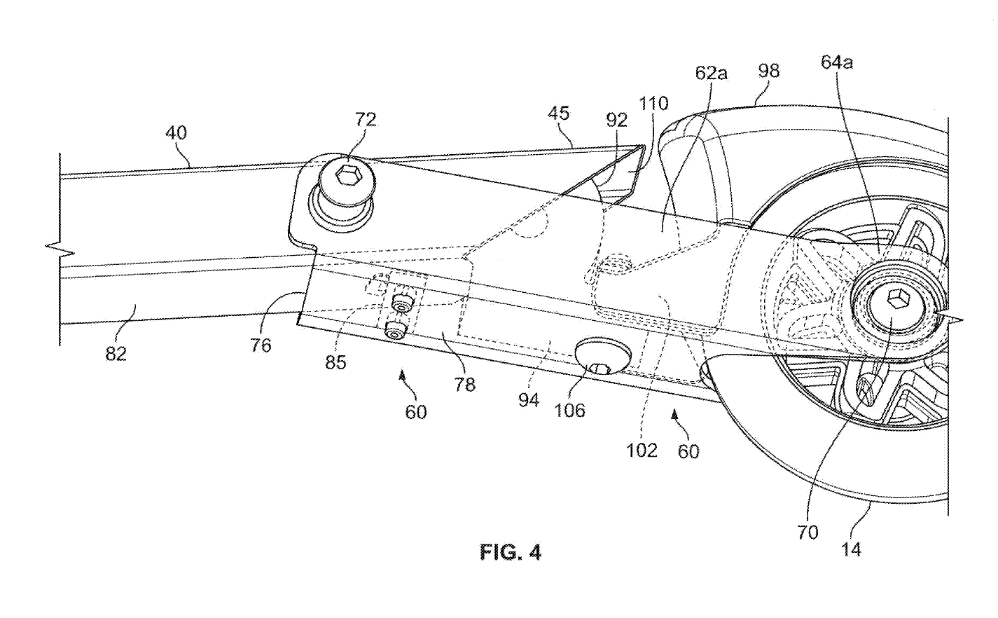

With reference to FIGS. 2 and 4, the leading end of the swing arm 60 receives the trailing portion of the deck frame 40 between swing arm sidewalls 62a and 62b. The components are secured together by bolt 72 which, with reference to FIG. 2, passes through openings 66a and 66b of the swing arm and openings 74a and 74b (not visible) of the deck frame 40. The swing arm 60 pivots with respect to the deck frame 40. With respect to FIG. 4, clockwise pivoting of the swing arm is limited by a downward swing arm stop defined by the leading edge 76 of the bottom 78 of the swing arm and the underside 82 of the deck frame 40. Counterclockwise pivoting of the swing arm 60 with respect to the deck frame 40 is limited by an upward swing arm stop defined by the top surface 84 of the swing arm bottom 78 and the underside 82 of the deck frame 40. More specifically, the swing arm 60 may travel clockwise with respect to the deck frame 40 until edge 76 of the swing arm engages the underside 82 of the deck frame. The swing arm 60 may alternatively travel counterclockwise with respect to the deck frame 40 until the top surface 84 of the swing arm bottom 78 engages the underside 82 of the deck frame. As illustrated in FIG. 4, a bumper 85 may optionally be provided on the top surface of the swing arm bottom 78 for the upward swing arm stop.

In addition to the swing arm 60, a swing arm assembly of the scooter includes a shock absorber, indicated in general at 90 in FIG. 2. The shock absorber features a cylindrical body portion 92 and a base portion 94. The shock absorber is preferably constructed of rubber, but any elastic material may be used.

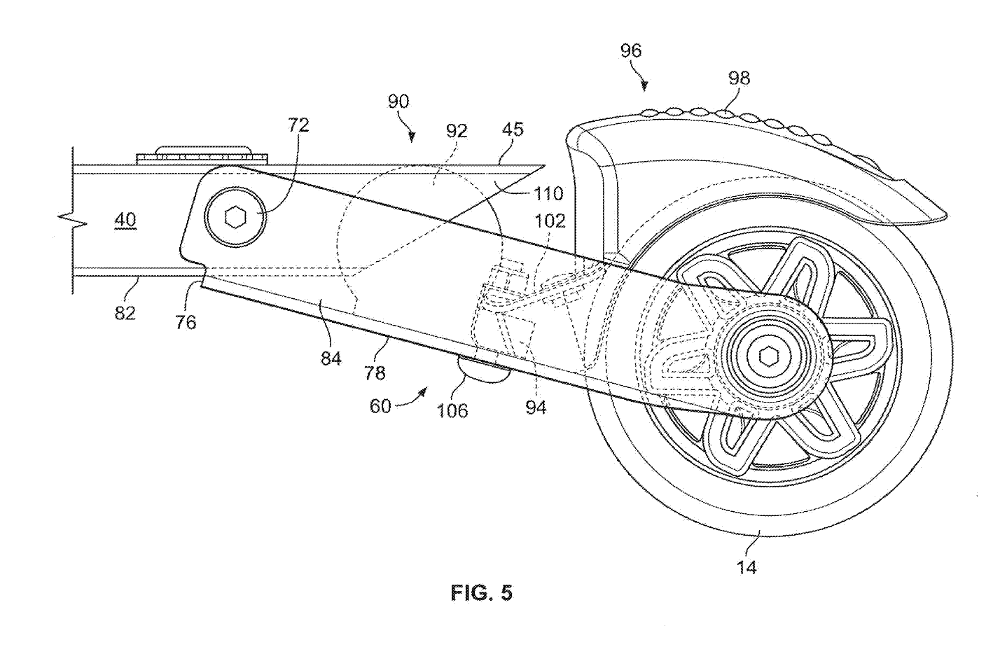

In addition, the swing arm assembly includes a rear fender, indicated in general at 96 in FIG. 2. Rear fender 96 is preferably molded from plastic, but alternative materials may be used. The rear fender 96 includes a generally arc-shaped upper portion 98 and a lower fastening portion 102. As illustrated in FIGS. 4 and 5, the shock absorber and rear fender are secured by their base portion 94 and lower fastening portion 102, respectively, to the bottom 78 of the swing arm by bolt 106. As a result, the shock absorber 90 and lower fastening portion 102 of the rear fender are positioned between the sidewalls 62a and 62b of the swing arm, while the generally arc-shaped upper portion of the fender is positioned over the rear wheel 14 to protect the rider from mud or other debris thrown from the rear wheel of the scooter.

As illustrated in FIGS. 4 and 5, the top of the shock absorber is in contact with, or otherwise generally positioned adjacent to (without contact), the underside 110 of the overhang portion 45 of the deck frame when the swing arm has pivoted clockwise to the maximum extent permitted by the downward swing arm stop (i.e. when the leading edge 76 of the swing arm bottom has engaged the underside 82 of the deck frame 40). As a result, counterclockwise movement of the swing arm 60 with respect to deck frame 40 is resisted by shock absorber 90.

Movement of the swing arm 60, and thus the swing arm assembly, is illustrated in FIGS. 6A and 6B. More specifically, FIG. 6A illustrates the scooter without a rider. This corresponds to FIGS. 4 and 5. When a rider steps onto the deck 12 of the scooter, the swing arm swings counterclockwise with respect to the deck 12 about bolt 72, as indicated by arrows 112, into the position illustrated in FIG. 6B. As this pivoting occurs, with reference to FIG. 5, the shock absorber 90 is compressed between the overhang-portion 45 of the deck frame 40 and the bottom 78 of the swing arm 60. As the scooter is ridden over a bumpy surface, further compression and rebounding of shock absorber 90 dampens the bumps and creates a suspension effect for the rider. As noted above, counterclockwise travel of the swing arm, and thus compression of the shock absorber 90, is limited by the engagement of surface 84 with the underside 82 of the deck frame 40.

Because the rear fender 96 is attached to the swing arm 60 in the manner described above, it travels up and down along with the up and down travel of the rear wheel 14 (again, as illustrated by arrows 112 in FIGS. 6A and 6B).

The design of the shock absorber 90, and the sole connection of the bottom of the shock absorber 90 to the swing arm 60, allows for a single assembly side with no connection to the deck frame (or any other part of the scooter). This simplifies and lowers the cost of assembly. The arrangement also simplifies the replacement of a worn shock absorber.

In an alternative embodiment of the invention, the shock absorber 90 may be inverted with respect to the orientation illustrated in FIGS. 2, 4 and 5 with the base portion 94 of the shock absorber fastened to the underside 110 of the overhang portion 45 of the deck frame (instead of to the bottom 78 of the swing arm) with the cylindrical body 92 of the shock absorber positioned generally adjacent to the bottom 78 of the swing arm (due to the downward swing arm stop).

The embodiment of the invention described above and illustrated in the figures provides an economical suspension system for a kick scooter in that it permits the use of low-cost materials, is simple to assemble and features few components. It is also durable so that it may withstand the rigors of child play.

While the preferred embodiments of the invention have been shown and described, it will be apparent to those skilled in the art that changes and modifications may be made therein without departing from the spirit of invention, the scope of which is defined by the appended claims.

What is claimed is:

1. A vehicle comprising:
a. a frame having a leading portion and a trailing portion;
b. a front wheel attached to the leading portion of the frame;
c. a swing arm having a leading portion and a trailing portion, the leading portion of the swing arm pivotally attached to the trailing portion of the frame;
d. a rear wheel attached to the trailing portion of the swing-arm;
e. a shock absorber having a first end and an opposite second end, the first end of the shock absorber attached to one of the swing arm or the frame and positioned between the swing arm and the frame so that the shock absorber is compressed between the swing arm and the frame when the swing arm pivots in a first direction with respect to the frame; and
f. a downward swing arm stop limiting pivoting of the swing arm in a second direction opposite of the first direction so that the second end of the shock absorber is maintained in a position generally adjacent to the frame or the swing arm.

2. The vehicle of claim 1 wherein the vehicle is a scooter and further comprising a deck positioned on and supported by the frame.

3. The vehicle of claim 2 further wherein the front wheel is attached to the leading portion of the frame by a front assembly, said front assembly comprising:
g. a gooseneck member having a leading end and a trailing end, where the trailing end is attached to the frame;
h. a head tube secured to the leading end of the gooseneck member;
i. a steering column having a top end and a bottom end;
j. a handlebar attached to the top end of the steering column;
k. a front fork attached to the bottom of the steering column, front wheel rotationally secured to the front fork.

4. The vehicle of claim 2 wherein the deck has a channel within which the frame is received.

5. The vehicle of claim 1 wherein the trailing portion of the frame is angled so that an overhang portion is formed, where a top of the shock absorber is maintained in a position generally adjacent to the overhang portion of the frame.

6. The vehicle of claim 1 wherein the swing arm is generally U-shaped so as to have a bottom and a pair of opposing sidewalls connected to the bottom with said -frame positioned between the opposing sidewalls.

7. The vehicle of claim 6 wherein the shock absorber is mounted to the bottom of the swing arm between the opposing sidewalls of the swing arm.

8. The vehicle of claim 7 further comprising a rear fender having an upper portion positioned over the rear wheel and a lower fastening portion secured to the bottom of the swing

9. The vehicle of claim 8 wherein the shock absorber and the rear fender are secured to the bottom of the swing arm by a common fastener.

10. The vehicle of claim 6 wherein the opposing sidewalls of the swing arm terminate at the trailing portion of the swing arm in an opposing pair of ears between which the rear wheel is rotationally mounted.

11. The vehicle of claim 6 wherein the frame is constructed from square tubing.

12. The vehicle of claim 1 further comprising a rear fender having an upper portion positioned over the rear wheel and a lower fastening portion secured to the swing arm.

13. The vehicle of claim 1 wherein the downward swing arm stop includes a leading edge of a bottom of the swing arm that engages an underside of the frame to limit pivoting of the swing arm in the second direction.

14. The vehicle of claim 1 further comprising an upward swing arm stop that limits pivoting of the swing arm in the first direction.

15. The vehicle of claim 14 wherein the upward swing arm stop includes a surface of the swing arm that engages an underside of the frame to limit pivoting of the swing arm in the first direction.

16. The vehicle of claim 15 wherein the surface of the swing arm is a top surface of a bottom of the swing arm.

17. The vehicle of claim 1 wherein the shock absorber includes a cylindrical body.

18. A swing arm assembly for a vehicle having a frame comprising:
a. a swing arm having a leading portion and a trailing portion, the leading portion of the swing arm adapted to be pivotally attached to the vehicle frame;
b. a rear wheel attached to the trailing portion of the swing arm;
c. a shock absorber having a top, said shock absorber attached to the swing arm and adapted to be positioned between the swing arm and the vehicle frame so that the shock absorber is compressed between the swing arm and the vehicle frame when the swing arm pivots in a first direction with respect to the vehicle frame; and
d. a downward swing, arm stop limiting pivoting of the swing arm in a second direction opposite of the first direction so that the top of the shock absorber is maintained in a position generally adjacent to the vehicle frame.

19. The swing arm assembly of claim 18 wherein the swing arm is generally U-shaped so as to have a bottom and a pair of opposing sidewalls connected to the bottom with said frame positioned between the opposing sidewalls.

20. The swing arm assembly of claim 19 wherein the shock absorber is mounted to the bottom of the swing arm between the opposing sidewalls of the swing arm.

21. The swing arm assembly of claim 20 further comprising a rear fender having an upper portion positioned over the rear wheel and a lower fastening portion secured to the bottom of the swing arm.

22. The swing arm assembly of claim 21 wherein the shock absorber and the rear fender are secured to the bottom of the swing arm by a common fastener.

23. The swing arm assembly of claim 19 wherein the opposing sidewalls of the swing arm terminate at the trailing portion of the swing arm in an opposing pair of ears between which the rear wheel is supported.

24. The swing arm assembly of claim 19 wherein the frame is constructed from square tubing.

25. The swing arm assembly of claim 18 further comprising a rear fender having an upper portion positioned over the rear wheel and a lower fastening portion secured to the swing arm.

26. The swing arm assembly of claim 18 wherein the downward swing arm stop includes a leading edge of a bottom of the swing arm that is adapted to engage an underside of the frame to limit pivoting of the swing arm in the second direction.

27. The swing arm assembly of claim 18 further comprising an upward swing arm stop that limits pivoting of the swing arm in the first direction.

28. The swing arm assembly of claim 27 wherein the upward swing an stop includes a surface on the swing arm that is adapted to engage an underside of the frame to limit pivoting of the swing arm in the first direction.

29. The swing arm assembly of claim 28 wherein the surface of the swing arm is a top surface of a bottom of the swing arm.

30. The swing arm assembly of claim 18 wherein the shock absorber includes a cylindrical body.

31. A method of providing a scooter with a suspension system, where the scooter includes a front assembly featuring a front wheel, a steering column and handlebars and a frame attached to the front assembly, the method comprising the steps of:
a providing a swing arm having a leading end and a trailing end, a rear wheel and a shock absorber having a first end and an opposite second end;
b. attaching the rear wheel to the trailing end of the swing arm in a rotating fashion;
c. attaching the first end of the shock absorber to the swing arm or the frame;
d. attaching the leading end of the swing arm to the frame in a pivoting fashion and so that a downward swing arm stop is created limiting pivoting of the swing arm so that the second end of the shock absorber is maintained in a position generally adjacent to the vehicle frame or swing arm.

32. The method of claim 31 further comprising the steps of:
e. providing a rear fender;
f. mounting the rear fender to the swing arm.
